(19) United States
(12) Patent Application Publication
(10) Pub. No.: US 2024/0143967 A1
(43) Pub. Date: May 2, 2024

(54) ANTI-COUNTERFEITING ELECTROMAGNETIC INDUCTION SEALING LINER

(71) Applicant: HI-JOINT TECHNOLOGIES CORPORATION, New Taipei City (TW)

(72) Inventor: YEN-WU YANG, New Taipei City (TW)

(21) Appl. No.: 17/975,631

(22) Filed: Oct. 28, 2022

(51) Int. Cl. G06K 19/077; H01Q 1/22

(52) U.S. Cl. CPC G06K 19/07798; G06K 19/0776; H01Q 1/2208

(57) ABSTRACT

An anti-counterfeiting electromagnetic induction sealing liner includes, from top to bottom order, a composite function layer, an electromagnetic induction heating layer, and an adhesion layer combined together. The composite function layer includes, from top to bottom order, an information layer and a support layer combined together. The information layer has therein an information chip and an antenna circuit electrically connected to the information chip. The composite function layer has a structurally weak region. The structurally weak region crosses the antenna circuit. The anti-counterfeiting electromagnetic induction sealing liner seals a container mouth and has an information read/write function. Therefore, the information layer is destroyed the first time the container mouth is opened, thereby improving the anti-counterfeiting function.

### BACKGROUND OF THE INVENTION

### 1. Field of the Invention

The present disclosure relates to container packaging, and in particular to an anti-counterfeiting electromagnetic induction sealing liner.

### 2. Description of the Related Art

According to the prior art, packages of some products come with information tags (usually RFID tags) for information to be written to and read from in order to track the products. Product information related to product model numbers, production history, logistics, and the like is written to the information tags.

Conventional information tags are mostly directly affixed to the outside of a product container, and thus the information tags can be peeled off and reused easily. However, the information tags may be peeled off by unscrupulous persons and affixed to the container of a fake product for reuse. Thus, there is still room for improvement in the anti-counterfeiting function of information tags. Therefore, it is necessary for the packaging industry to address the issue of improving the anti-counterfeiting function of information tags.

### BRIEF SUMMARY OF THE INVENTION

It is an objective of the present disclosure to provide an anti-counterfeiting electromagnetic induction sealing liner for sealing a container mouth, having an information read/write function, and being able to destroy an information layer the first time the container mouth is opened, so as to improve the prior art.

In order to achieve the above and other objectives, the present disclosure provides an anti-counterfeiting electromagnetic induction sealing liner comprising, from top to bottom order, a composite function layer, an electromagnetic induction heating layer, and an adhesion layer combined together. The composite function layer comprises, from top to bottom order, an information layer and a support layer combined together. The information layer has therein an information chip and an antenna circuit electrically connected to the information chip. The composite function layer has a structurally weak region. The structurally weak region crosses the antenna circuit.

A lateral edge of the anti-counterfeiting electromagnetic induction sealing liner extends to form a lug portion.

The structurally weak region of the composite function layer is a continuous groove structure or is formed from notches spaced apart from each other.

The structurally weak region is V-shaped or U-shaped or is in the shape of parallel lines.

The information layer comprises a surface film, a base film, the information chip and the antenna circuit, and both the information chip and the antenna circuit are sandwiched between the surface film and the base film.

The information chip is, for example, a Radio-Frequency Identification (RFID) chip, a Near Field Communication Identification (NFCID) chip, an Electro-Magnetic Identification (EMID) chip or an Ultra-Wideband Identification (UWBID) chip.

The support layer is for example, a plastic film, a cardboard, a foam board, or a plastic board.

The electromagnetic induction heating layer is, for example, an aluminum foil layer or an aluminum-plastic film layer.

The adhesion layer is made of, for example, polyethylene, polyethylene glycol terephthalate, polypropylene, or hot-melt adhesive.

Therefore, the anti-counterfeiting electromagnetic induction sealing liner of the present disclosure seals a container mouth and comes with an information layer capable of performing an information read/write function. To open the container mouth, a user has to remove a container cap from the container mouth and then peel the anti-counterfeiting electromagnetic induction sealing liner off of the container mouth. Since the composite function layer has the structurally weak region, the structurally weak region of the composite function layer severs as soon as the user peels off the anti-counterfeiting electromagnetic induction sealing liner. Since the structurally weak region crosses the antenna circuit, the severance of the structurally weak region causes the antenna circuit to sever, leading to the destruction of the information layer and the resultant loss of the information read/write function. Therefore, the information layer is destroyed the first time the container mouth is opened, thereby improving the anti-counterfeiting function.

### BRIEF DESCRIPTION OF THE DRAWINGS

FIG. 1 is a top view of an anti-counterfeiting electromagnetic induction sealing liner in an embodiment of the present disclosure.

FIG. 2 is a top view of the anti-counterfeiting electromagnetic induction sealing liner in an embodiment of the present disclosure.

FIG. 3 is a top view of the anti-counterfeiting electromagnetic induction sealing liner in an embodiment of the present disclosure.

FIG. 4 is a side view of the anti-counterfeiting electromagnetic induction sealing liner of an embodiment of the present disclosure.

FIG. 5 is an exploded view of an information layer of an embodiment of the present disclosure.

### DETAILED DESCRIPTION OF THE INVENTION

Technical features of the present disclosure are herein illustrated with specific embodiments.

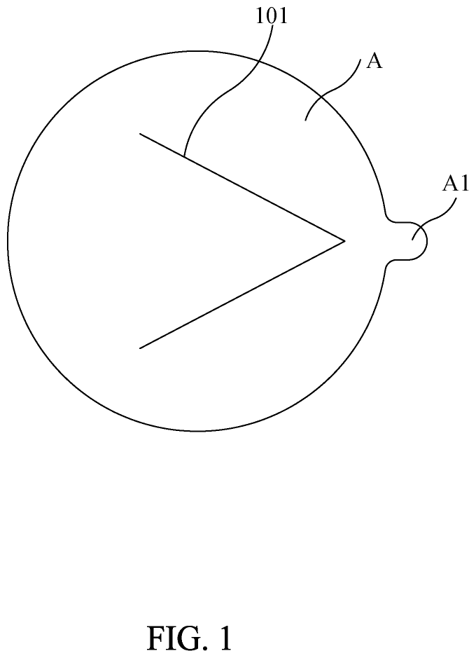

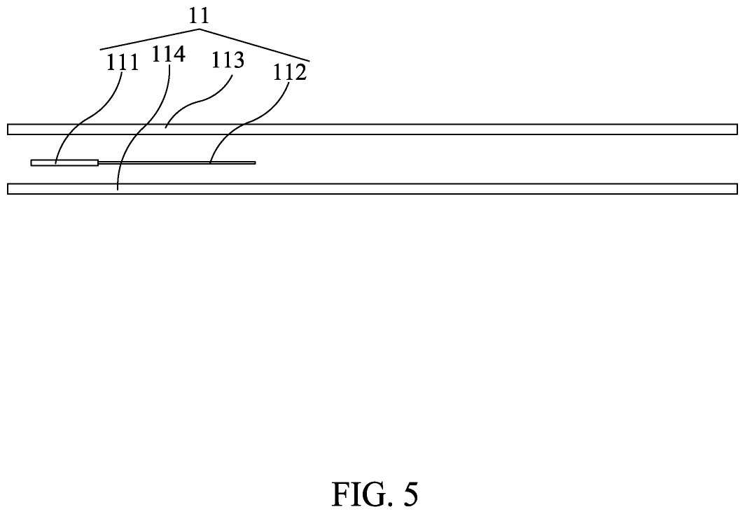

Referring to FIG. 1 through FIG. 5, the present disclosure provides an anti-counterfeiting electromagnetic induction sealing liner A comprising, from top to bottom order, a composite function layer 1, an electromagnetic induction heating layer 2 and an adhesion layer 3 combined together. The composite function layer 1 comprises, from top to bottom order, an information layer 11 and a support layer 12 combined together. The information layer 11 has an information read/write function. The information layer 11 has therein an information chip 111 and an antenna circuit 112 electrically connected to the information chip 111. The information chip 111 is, for example, a Radio-Frequency Identification (RFID) chip, a Near Field Communication Identification (NFCID) chip, an Electro-Magnetic Identification (EMID) chip or an Ultra-Wideband Identification (UWBID) chip. The composite function layer 1 has a structurally weak region 101. The structurally weak region 101 crosses the antenna circuit 112.

According to the present disclosure, the anti-counterfeiting electromagnetic induction sealing liner A seals a container mouth in a process explained below. An electromagnetic field is generated with an electromagnetic induction sealing machine. Heat is generated by the electromagnetic induction heating layer 2 because of electromagnetic induction. The adhesion layer 3 is melted by the heat and thus adhered to the container mouth, allowing the anti-counterfeiting electromagnetic induction sealing liner A to seal the container mouth. After the anti-counterfeiting electromagnetic induction sealing liner A has sealed the container mouth, a user may read/write product information from/to the information chip 111 of the information layer 11 with an information read/write device, such as an RFID reader/writer or NFCID reader/writer.

According to the present disclosure, to open the container mouth, the user has to remove a container cap from the container mouth and then peel the anti-counterfeiting electromagnetic induction sealing liner A off the container mouth. Since the composite function layer 1 has the structurally weak region 101, the structurally weak region 101 of the composite function layer 1 severs as soon as the user peels off the anti-counterfeiting electromagnetic induction sealing liner A. Since the structurally weak region 101 crosses the antenna circuit 112, the severance of the structurally weak region 101 causes the antenna circuit 112 to sever, leading to the destruction of the information layer 11 and the resultant loss of the information read/write function. Therefore, the information layer 11 is destroyed the first time the container mouth is opened, thereby improving the anti-counterfeiting function.

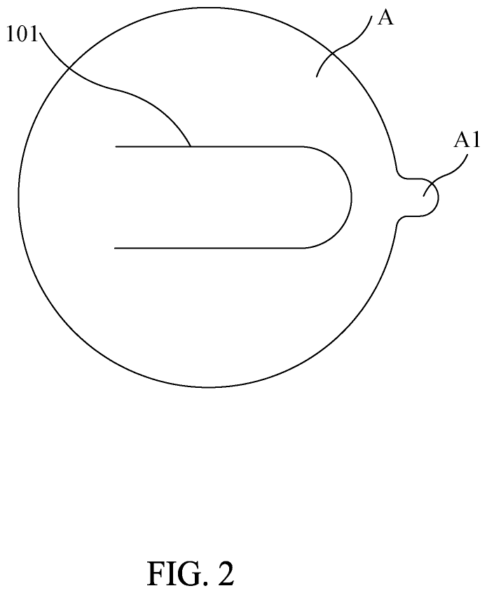

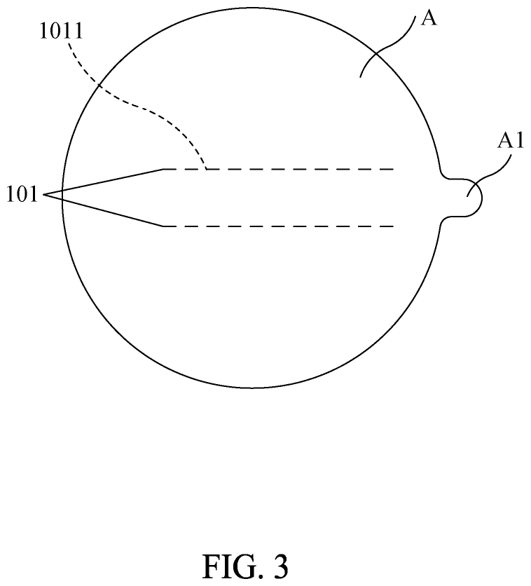

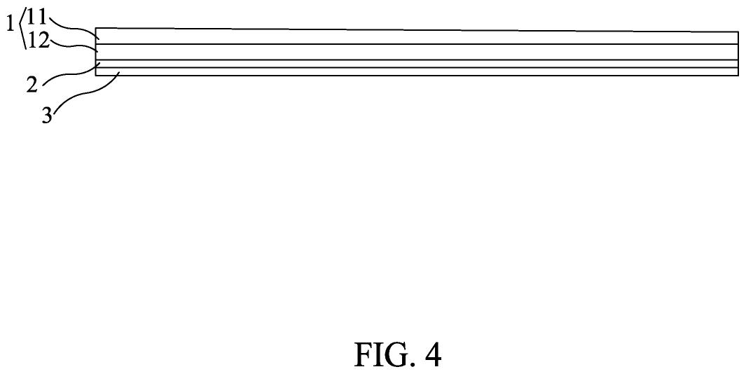

According to the present disclosure, a lateral edge of the anti-counterfeiting electromagnetic induction sealing liner A extends to form a lug portion A1. The user grips the lug portion A1 by hand to easily peel the anti-counterfeiting electromagnetic induction sealing liner A off of the container mouth. According to the present disclosure, the structurally weak region 101 of the composite function layer 1 is formed by a physical process, such as, for example, mold micro-pressing, laser microdissection, or electron beam microdissection. Referring to FIG. 1 and FIG. 2, in embodiments of the present disclosure, the structurally weak region 101 of the composite function layer 1 is, for example, a continuous groove structure, is structurally weak, and thus severs as soon as the user peels the anti-counterfeiting electromagnetic induction sealing liner A off of the container mouth. Referring to FIG. 3 and FIG. 4, in embodiments of the present disclosure, the structurally weak region 101 of the composite function layer 1 is formed from notches 1011 spaced apart from each other and thus is thin enough to sever as soon as the user peels the anti-counterfeiting electromagnetic induction sealing liner A off of the container mouth.

According to the present disclosure, the structure of the structurally weak region 101 of the composite function layer 1 is subject to changes as needed. Referring to FIG. 1, in an embodiment of the present disclosure, the structurally weak region 101 is V-shaped. Referring to FIG. 2, in an embodiment of the present disclosure, the structurally weak region 101 is U-shaped. Referring to FIG. 3, in an embodiment of the present disclosure, the structurally weak region 101 is in the shape of parallel lines.

According to the present disclosure, the information layer 11 comprises a surface film 113, a base film 114, the information chip 111, and the antenna circuit 112, and both the information chip 111 and the antenna circuit 112 are sandwiched between the surface film 113 and the base film 114. The surface film 113 and the base film 114 are made of, for example, polyethylene, polyethylene glycol terephthalate, or polypropylene. The information chip 111 is, for example, an RFID chip, an NFCID chip, an EMID chip, or a UWBID chip. The RFID chip, the NFCID chip, the EMID chip, and the UWBID chip are equally effective in performing an information read/write function with the antenna circuit 112. The antenna circuit 112 has a structurally weak region which renders the antenna circuit 112 easy to sever in response to the severance of a primary cutting line and a secondary cutting line. The structurally weak region has small antenna dimensions and is thin, when compared to the antenna circuit 112 in its entirety. The structurally weak region may also be a region where the antenna material is likely to fracture or sever.

According to the present disclosure, the support layer 12 comprises, for example, plastic film, cardboard, foam board, or plastic board, and is combined with the electromagnetic induction heating layer 2, using glue.

According to the present disclosure, the electromagnetic induction heating layer 2 is, for example, an aluminum foil layer or an aluminum-plastic film layer. The aluminum foil layer or the aluminum-plastic film layer generates heat when exposed to a varying electromagnetic field.

According to the present disclosure, the adhesion layer 3 comprises, for example, polyethylene, polyethylene glycol terephthalate, polypropylene, or hot-melt adhesive. The adhesion layer 3 may also be made of any other material, as long as the adhesion layer 3 adheres to the container mouth when heated up.

The aforesaid embodiments and accompanying drawings are not restrictive of the product forms and styles of the disclosure. Appropriate changes and modifications made by persons skilled in the art to the aforesaid embodiments and accompanying drawings shall be deemed to fall within the scope of the claims of the disclosure.

1. An anti-counterfeiting electromagnetic induction sealing liner comprising:
a composite function layer;
an electromagnetic induction heating layer in contact with the composite function layer; and
an adhesion layer in contact with the electromagnetic induction heating layer;
wherein the composite function layer comprises, from top to bottom order, an information layer and a support layer connected together, the information layer having therein an information chip and an antenna circuit electrically connected to the information chip;
wherein the composite function layer has a structurally weak region, and the structurally weak region crosses the antenna circuit;
wherein the support layer comprises cardboard, foam board, or plastic board, and is combined with the electromagnetic induction heating layer, using glue.

2. The anti-counterfeiting electromagnetic induction sealing liner according to claim 1, wherein a lateral edge of the anti-counterfeiting electromagnetic induction sealing liner extends to form a grip portion.

3. The anti-counterfeiting electromagnetic induction sealing liner according to claim 1, wherein the structurally weak region of the composite function layer is a continuous groove structure or is formed from notches spaced apart from each other.

4. The anti-counterfeiting electromagnetic induction sealing liner according to claim 1, wherein the structurally weak region is V-shaped, U-shaped, or is in the shape of parallel lines.

5. The anti-counterfeiting electromagnetic induction sealing liner according to claim 3, wherein the structurally weak region is V-shaped, U-shaped, or is in the shape of parallel lines.

6. The anti-counterfeiting electromagnetic induction sealing liner according to claim 1, wherein the information layer comprises a surface film, a base film, the information chip, and the antenna circuit, and both the information chip and the antenna circuit are sandwiched between the surface film and the base film, and the surface film is farther away from the support layer than the base film.

7. The anti-counterfeiting electromagnetic induction sealing liner according to claim 1, wherein the information chip is a radio-frequency identification (RFID) chip, a near field communication identification (NFCID) chip, an electro-magnetic identification (EMID) chip or an ultra-wideband identification (UWBID) chip.

8. The anti-counterfeiting electromagnetic induction sealing liner according to claim 6, wherein the information chip is a radio-frequency identification (RFID) chip, a near field communication identification (NFCID) chip, an electro-magnetic identification (EMID) chip or an ultra-wideband identification (UWBID) chip.

9. The anti-counterfeiting electromagnetic induction sealing liner according to claim 6, wherein the surface film and the base film comprise polyethylene, polyethylene glycol terephthalate, or polypropylene.

10. (canceled)

11. The anti-counterfeiting electromagnetic induction sealing liner according to claim 1, wherein the electromagnetic induction heating layer comprises an aluminum foil layer or an aluminum-plastic film layer.

12. The anti-counterfeiting electromagnetic induction sealing liner according to claim 1, wherein the adhesion layer comprises polyethylene, polyethylene glycol terephthalate, polypropylene, or hot-melt adhesive.
